(19) United States
(12) Patent Application Publication
(10) Pub. No.: US 2006/0073310 A1
(43) Pub. Date: Apr. 6, 2006

(54) Cover for a unit in the engine compartment of a motor vehicle

(76) Inventor: Detlef Winkler, Wolfsburg (DE)

Correspondence Address: WILLIAM COLLARD;COLLARD & ROE, P.C., 1077 NORTHERN BOULEVARD, ROSLYN, NY, 11576, US

(21) Appl. No.: 10/549,094

(22) PCT Filed: Mar. 20, 2004
(86) PCT No.: PCT/EP04/02957

§ 371 Date: Sep. 13, 2005

(30) Foreign Application Priority Data
Apr. 14, 2003 (DE) 103 17 305.6

(51) Int. Cl. B32B 3/12

(52) U.S. Cl. 428/158

(57) ABSTRACT

The invention relates to a cover (1) for a unit in the engine compartment of a motor vehicle, having a support part (2) and a molded part (3) attached to it in one piece and made of a sound-absorbing material. The object of the invention is to provide a cover for a unit in the engine compartment of a motor vehicle, especially an engine cover that has improved acoustic efficiency and at the same time can be installed especially easily. This object is solved in that the molded part (3) has on its side facing away from the supporting part (2) a collar (4) which is assigned to the unit that is to be covered, and in that the plug-in coupling elements (6) that are provided for assembly of the cover (1) on the unit are connected in a form-fitting manner to the sound-absorbing material of the molded part (3) and are arranged at a distance from the supporting part (2). The molded part is preferably formed by back-foaming the back of the support (2). The plug-in coupling elements (6) can be embedded in the foam material of the molded part (3).

The invention relates to a cover for a unit in the engine compartment of a motor vehicle, having a support part and a molded part attached to it in one piece and made of a sound-absorbing material.

Motor vehicles today are increasingly equipped with sound-absorbing engine covers, which regularly also have a design function.

German Patent DE 40 41 388 C2 describes an internal combustion engine having an acoustic hood that extends over the cylinder head cover. The acoustic hood is a self-supporting molded part designed with a single layer in cross section. A peripheral closed sealing ring is applied to the edge of the acoustic hood, forming a sealing contact with the end face side-of a control box covering a toothed belt and the edge faces and/or surface of the cylinder head cover. The acoustic hood is attached to the cylinder head by means of stud bolts which are screwed into a threaded bore in the cylinder head and have an outer thread section on their other end. The outer thread section extends through a sleeve which is acoustically insulated by a rubber bushing and is connected to the acoustic hood. The acoustic hood is held by a cap nut screwed onto the threaded section. Because of the absence of a sound-absorbing material such as foam or the like, the acoustic efficiency of the acoustic hood is not satisfactory. Furthermore, the assembly of this acoustic hood is relatively inconvenient due to the fact that cap nuts must be screwed onto it.

From German patent application DE 199 04 986 A1 a sound-absorbing engine cover is known which has multiple cover layers of foam material with a filler layer of foam material arranged in a predetermined area between two cover layers. The cover is attached by ultrasonic welding to a plastic shell, which functions as a design cover. Furthermore, the sound-absorbing cover has recesses to allow components of the plastic shell to pass through. With regard to the fastening of the cover and/or the plastic shell to the unit to be covered, German patent application DE 199 04 986 A1 does not contain any detailed information.

Furthermore, with regard to the state of the art, reference should be made to German patent application DE 198 24 905 A1. This patent describes a cover shell for internal combustion engines having vibration-isolating spring elements directly cast thereon in one piece in the manner of conical compression springs or membrane springs with an assembly cage. The cover shell and the integral spring elements are made of the same material, namely plastic, in one operation and thus form a unit. Mounting and dismantling devices should be attached to the ends of the spring elements. However, it is not clear what the concrete design of these mounting and dismantling devices, which are evidently also integrated into one operation, is to be. In addition, the proposed spring elements require relatively complex injection molds, which lead to high manufacturing costs accordingly and can also entail quality problems. Moreover, this known cover shell is not provided with sound-absorbing material, so its acoustic effect is hardly satisfactory.

The object of the present invention is to provide a cover for a unit in the engine compartment of a motor vehicle, in particular an engine cover which has an improved acoustic efficiency and at the same time can be installed especially easily.

According to this invention, this object is achieved with a cover of the type defined in the preamble in that the molded part has on its side facing away from the supporting part a collar provided for the unit that is to be covered, and plug-in coupling elements which serve to assemble the cover on the unit are provided, these elements being connected in a form-fitting manner to the sound-absorbing material of the molded part at a distance from the supporting part.

Due to the molded part made of a sound-absorbing material, preferably foam, the cover according to the invention has an improved acoustic efficiency in comparison with conventional design hoods or acoustic hoods such as those known from German patent DE 40 41 388 C2 and German patent application DE 198 24-905 A1, for example. The acoustic efficiency of the cover according to the invention is further improved with the collar, which is formed on the molded part and largely or completely surrounds the unit to be covered at the side. The collar, which is preferably designed to run around, may have sections of different widths or depths, depending on the geometry of the engine part to be covered or to be insulated acoustically.

In addition, the cover according to the invention can be installed and dismantled very easily and quickly due to the plug-in coupling elements. The form-fitting connection of the plug-in coupling elements with the molded part has the advantage in particular that the plug-in coupling elements are integral components of the cover, so that the number of components to be handled in installation and dismantling of the cover is reduced. This makes it possible to reduce storage costs and prevent problems caused by possibly missing parts. In addition, this form-fitting connection has the advantage that the supporting part of the cover is insulated especially well with respect to vibration of the unit to be covered, in particular the vibration of an internal combustion engine. In particular a molded part made of soft elastic material such as foam assumes a vibration-insulating effect in addition to the sound absorption effect.

The molded part may advantageously be formed by back-foaming the supporting part. In this case the plug-in coupling elements may be arranged in the injection mold in such a way that they are surrounded by the foam of the molded part.

According to another advantageous embodiment of this invention, the collar has on its outside in at least some sections a heavy layer, e.g., made of a filled thermoplastic elastomer. The collar, which is preferably made of an elastic open-pored foam, and the heavy layer together then form an acoustic spring-mass system which increases the sound-absorbing and sound-insulating effect of the cover according to the invention.

Additional preferred and advantageous embodiments of the inventive cover are characterized in the subclaims.

This invention is explained in greater detail below on the basis of a drawing which depicts several exemplary embodiments, showing in schematic illustration:

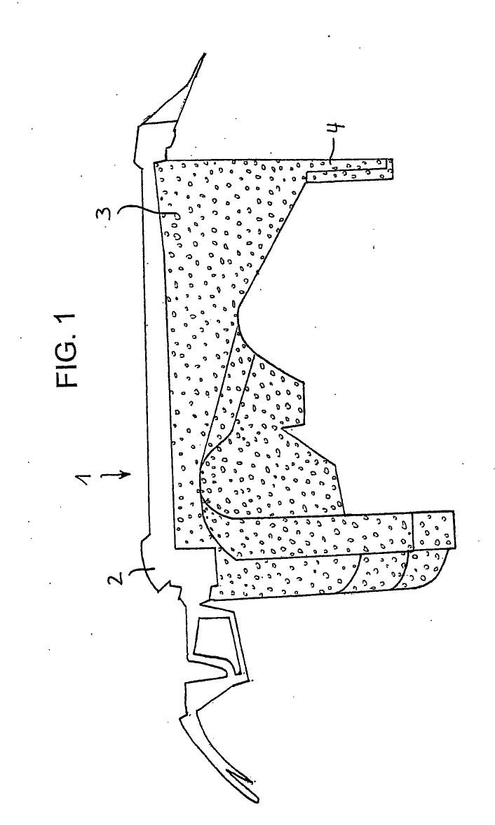

FIG. 1 a side view of an engine cover for a motor vehicle;

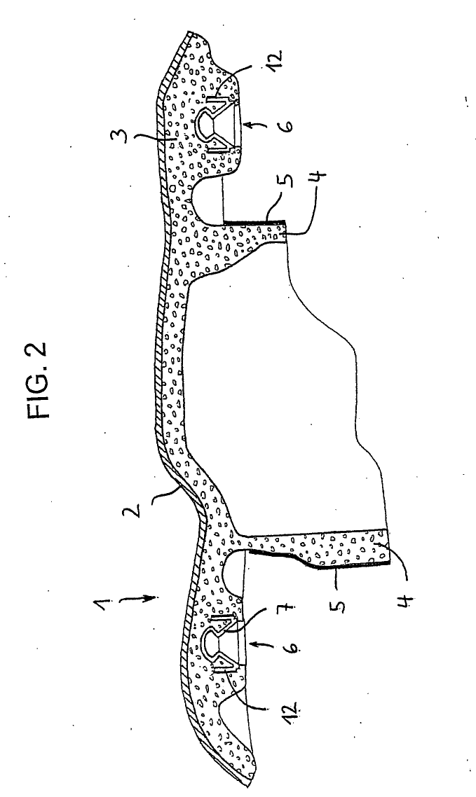

FIG. 2 a sectional view of an engine cover according to FIG. 1;

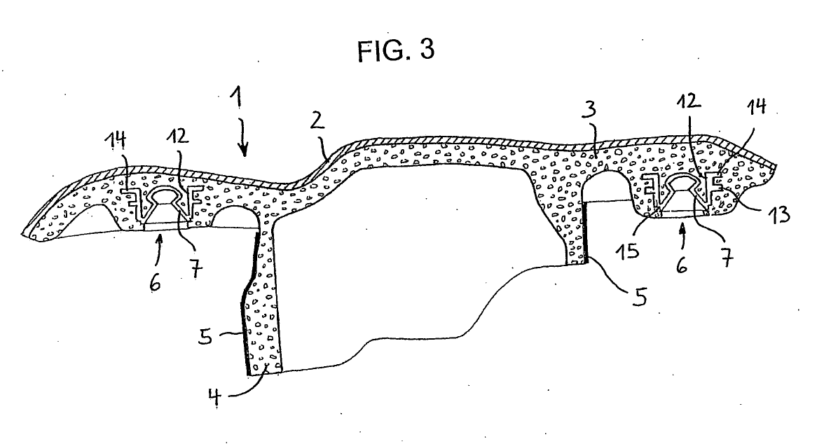

FIG. 3 a sectional view of an engine cover according to a second exemplary embodiment;

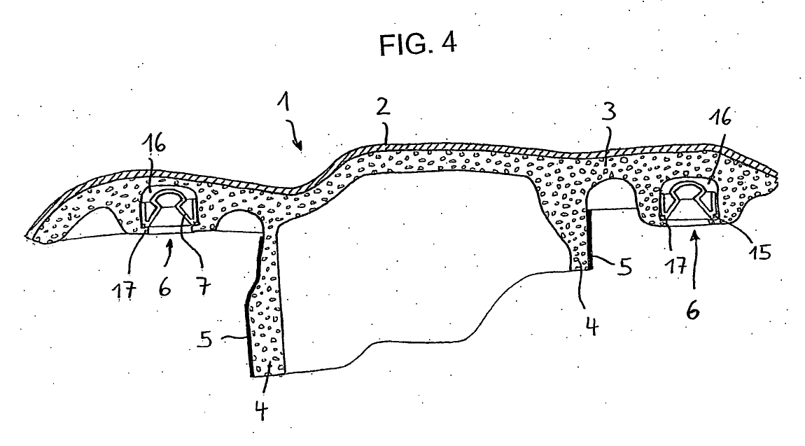

FIG. 4 a sectional view of an engine cover according to a third exemplary embodiment; and

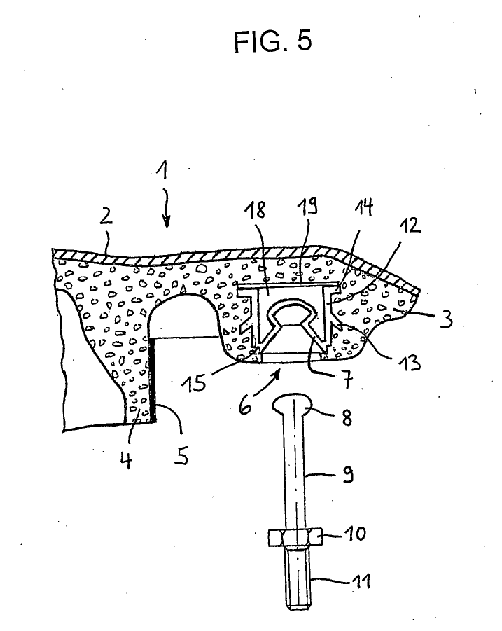

FIG. 5 a sectional view of a section of an engine cover according to a fourth exemplary embodiment.

The cover 1 shown in the drawing is an engine cover having both a design function and an acoustic function. The cover 1 is made of a supporting part 2, which is self-supporting, and a molded part 3 connected to it in one piece and made of a material that absorbs airborne sound. The supporting part 2 is made of plastic, e.g., polyamide. If desired, the supporting part 2 or its visible side may also be made of metal, preferably aluminum.

The supporting part 2 may be in particular a plastic molded part having a film on its visible side and a backing produced by injection molding on the back side of the film, wherein the film is a completely dyed plastic film, preferably consisting of the same type of plastic as the rest of the supporting part 2.

The completely dyed plastic film (not shown) has a thickness of approximately 300 to 400 μm and is shaped according to a defined contour and then cut to size. The plastic film processed in this way is backed as a film insert by injection molding with polyamide or another suitable plastic in an injection mold. The plastic film may, if desired, cover only partial areas of the visible side of the supporting part 2. It has a color which differs from that of the back-injected plastic. For example, the plastic film may have a silver color while the backing plastic is black. The supporting part 2 is thus a design part in which both the shape and color are design elements.

The molded part 3 which is joined in one piece to the supporting part 2 that has a relatively great flexural stiffness is preferably made of foam. The foam may be, for example, polyurethane foam, polyethylene foam or melamine resin foam. It is preferably an open-pored foam material with hydrophobic and oleophobic properties.

The molded part 3 which absorbs airborne sound is preferably formed by back-foaming the supporting part 2. Accordingly, there is a bonded connection between the supporting part 2 and the molded part 3 over a large area.

On its side facing away from the supporting part 2, the molded part 3 has a peripheral collar 4. The collar 4 is designed in one piece with the molded part 3, i.e., the collar 4 is part of the molded part 3. The collar 4 may optionally be interrupted by recesses for arranging lines. The contour of the collar 4 is adapted to that of the engine part to be covered (not shown). Accordingly, the collar 4. has sections protruding downward to different extents. The molded-part 3 may be in. direct contact with the engine in the area of the collar 4. However, the molded part 3 is preferably designed. so that an air gap is provided between the engine part to be covered and the molded part 3, including the collar 4.

The outside of the collar 4 may be coated at least partially with a heavy layer 5, in particular with a highly filled thermoplastic elastomer, so that the collar 4 forms an acoustic spring-mass system.

For detachable fastening of the acoustic cover 1, plug-in coupling elements 6 are provided; they are connected in a form-fitting manner to the sound-absorbent material of the molded part 3 in such a way that they are arranged at a distance from the supporting part 2. The plug-in coupling elements 6 are made of a rubber elastic material, e.g., a thermoplastic elastomer. They each have a coupling section 7 designed in the manner of a catch coupling. A mushroom-shaped or ball-shaped head 8 of a stud bolt 9 which is mounted on the engine of the motor vehicle can be engaged in this coupling section 7 (see FIG. 5). As shown in FIG. 5, the stud bolt 9 may therefore have a hexagonal section 10 and an outside thread 11 which can be screwed into a matching threaded. bore in the engine (not shown). The arrangement of the plug-in coupling elements 6 corresponds to the arrangement of the stud bolts 9. The engine cover 1 according to the invention can thus be rapidly and easily installed and/or dismantled by connecting and disconnecting the plug-in coupling elements.

As shown in FIGS. 2, 3 and 5, the plug-in coupling elements 6 are integrated into the foam of the molded part 3. They are arranged outside of the collar 4 here. To produce an especially sturdy connection between the respective plug-in coupling element 6 and the foam, the plug-in coupling element has projections 12 which enlarge the surface area. These projections 12 are designed in the form of chambers or sleeves and may have flanges 14 and/or protrusions 13 that protrude radially in particular, as shown in FIGS. 3 and 5. A transition area 15 having a reduced wall thickness is formed between the surface-increasing projection 12 and the coupling section 7 that can be connected to a web or a bolt. In the exemplary embodiment depicted here, the transition area 15 that has a reduced wall thickness is formed by a peripheral notch and/or groove. The transition area 15 has the function of a vibration-isolating spring and/or spring membrane.

As mentioned above, the foam of the molded part 3 in the cover 1 according to the invention not only has a sound-absorbing function but at the same time also has a vibration-isolating and/or vibration decoupling function between the covered vibrating engine part and the supporting part 2 of the engine cover 1. With regard to the vibration isolation, it may be advantageous if the molded part 3 has chamber-like recesses 16 in which each of the plug-in coupling elements 6 is supported in a form-fitting manner (see FIG. 4). The dimensions of the chamber-like recesses 16 and the plug-in coupling elements 6 are selected so that a coupling section 7 of the respective plug-in coupling element 6 which can be connected to a web or a bolt is mounted vibratably within the chamber-like recess 16. As shown in FIG. 4, the vibratable coupling section 7 which can be connected to a web or bolt is arranged at a distance not only from the supporting part 2 but also from the foam of the molded part 3. The chamber-like recess 16 has at its opening a shoulder-like protrusion 17 which additionally secures the plug-in coupling-element 6 to prevent its extraction from the chamber-like recess 16.

FIG. 5 shows an exemplary embodiment in which the plug-in coupling element 6 is again integrated into the foam. This plug-in coupling element 6 has a chamber-like and/or sleeve-like projection 12 which has a peripheral flange 14 and barb-like protrusions 13 protruding away from the outside thereof. The chamber-like and/or sleeve-like projection 12 defines a hollow space 18 which is provided with a closure 19. In the present exemplary embodiment, the closure 19 is formed by an adhesive film or the like which is applied to the flange 14. The coupling section 7 which can be connected to a mushroom-shaped or ball-shaped head 8 of a stud bolt 9 is mounted inside the hollow space 18 defined by the chamber-shaped or shell-shaped projection 12 in such a way that it can vibrate.

The features of the present invention disclosed in the preceding description and the claims and illustrated in the accompanying drawing may be essential to the implementation of the present invention in its various embodiments both individually and in any desired combination.

The performance of the present invention is not limited to the exemplary embodiments described above but instead several different variants are conceivable, which also in a fundamentally different design make use of the inventive idea as characterized in the claims. Thus the sound-absorbing molded part 3 may be constructed of several foam layers and/or areas joined together in one piece, each layer or area having different properties, in particular a different weight per unit of volume.

1. A cover (1) for a unit in the engine compartment of a motor vehicle, having a supporting part (2) and a molded part (3) made of a sound-absorbing material attached to the former in one piece,
wherein the molded part (3) has a collar (4) on its side facing away from the supporting part (2), said collar being assigned to the unit that is to be covered and plug-in coupling elements (6) that are provided for assembly of the cover (1) on the unit are connected in a form-fitting manner to the sound-absorbing material of the molded part (3) and are arranged at a distance from the supporting part (2).

2. The cover according to claim 1,
wherein the plug-in coupling elements (6) each have a coupling section (7) designed in the form of a catch coupling.

3. The cover according to claim 1, wherein the plug-in coupling elements (6) each have a vibratable coupling section (7) which can be connected to a web or a bolt (9) and is arranged at a distance from the molded part (3).

4. The cover according to claim 1, wherein
the molded part (3) is made of foam.

5. The cover according to claim 4,
wherein the plug-in coupling elements (6) are integrated into the foam.

6. The cover according to claim 1, wherein the molded part (3) is formed by foaming a backing onto the supporting part (2).

7. The cover according to claim 1, wherein the molded part (3) has chamber-like recesses (16) in which one of the plug-in coupling elements (6) is mounted in a form-fitting manner.

8. The cover according to claim 1, wherein the supporting part (2) is a plastic molded part having a back-injected film, said plastic molded part has a completely dyed plastic film on the visible side.

9. The cover according to claim 1, wherein the supporting part (2) or its visible side is made of aluminum.

10. The cover according to claim 1, wherein the collar (4) has a heavy layer (5) in at least some sections on its outside.

11. The cover according to claim 1, wherein the molded part (3) including the collar (4) is arranged at a distance from the unit to be covered.
